(19) United States
(12) Patent Application Publication
(10) Pub. No.: US 2015/0019614 A1
(43) Pub. Date: Jan. 15, 2015

(54) METHOD AND SYSTEM OF MANAGING AND DELIVERING VARIOUS FORMS OF CONTENT

(71) Applicant: Sherra Pierre-March, Nyack, NY (US)

(72) Inventor: Sherra Pierre-March, Nyack, NY (US)

(21) Appl. No.: 14/326,146

(22) Filed: Jul. 8, 2014

Related U.S. Application Data
(60) Provisional application No. 61/843,910, filed on Jul. 9, 2013.

(51) Int. Cl. H04L 29/08

(52) U.S. Cl. CPC H04L 67/10; H04L 67/32
USPC 709/201

(57) ABSTRACT

This document describes a method and system through which various forms of content may be ingested, managed, converted, repurposed, and delivered to content-accessing users. The method and system are comprised, in essence, of a software based platform, which may be itself primarily a unique closed environment and/or accessible primarily via a more open configuration (such as via a cloud based digital ecosystem). For example, the system may constitute an enterprise application solution that allows for centralized governance and controls over content in various formats and forms. As a turnkey platform—supporting media management, workflow execution, distribution and monetization—the method and system enable media sharing across multiple devices and operating systems inclusive of, for example, stand alone computers, hand-hand mobile devices, and more. The method and system also facilitate immediate integration with content publishing platforms in support of, for instance, live streaming (audio and video), on demand transmission, and print publishing.

### COPYRIGHT NOTICE

A portion of the disclosure of this patent application contains material that is subject to copyright protection. Noting the confidential protection afforded provisional patent applications, the copyright owner hereby authorizes the U.S. Patent and Trademark Office to reproduce this document and portions thereof as necessary for its records. The copyright owner otherwise reserves all copyright rights whatsoever.

### FIELD OF INVENTION

This invention relates generally to the ingestion, management, conversion, repurposing, and delivery to content-accessing users of various forms of content accessible via various devices.

### BACKGROUND

Technology supporting the management and delivery of content continually evolves. Organizations and individuals, through various disparate components and processes, have been able to manage content, while other offerings enable distribution. Independent from the foregoing, content-empowered users have also employed various systems and have used numerous methods to index and store content. Oftentimes, at relatively great expense, content-empowered users have commissioned third parties or have themselves built components and developed processes to, as easily as possible, facilitate interoperability between various components and processes of their desired operations. Maintenance of these custom systems and processes can be time-consuming and expensive, as the disparate components and processes evolve, becoming antiquated, or—relative to the other components and processes—do not continue to provide the desired operability.

The shortfalls of existing systems and methods became more apparent as organizations and individuals have (A) become increasingly aware of the importance of ‘online channeling’ (in essence, getting content from ‘here’ to ‘there’), (B) seen the success of social computing applications like YouTube and sharing applications like File Share, and (C) wanted to employ more rich media assets to improve customer experiences through both B2B and B2C offerings. Further, the increases in network bandwidth and speed have led organizations and individuals to seek efficiencies in digital transfer of content with the hope for saving operational costs. This need has been shared by managers and users of growing libraries of content, who have sought assistance in their reusing and repurposing of content, and have wished to integrate comprehensive workflow utilities capable of enabling both full control of content sharing, and ease of distribution.

The reader should consider, for example, the following:
Organizations and individuals traditionally have had difficulty managing their rich media assets. For example, marketers, who have required more insight into creative workflows (both internally and externally), have needed to manage brand protection and brand consistency across multiple channels. In particular, they have wanted systems that will help them increase speed-to-market and prevent duplication and rework (which occurs, for example, when previously-created but unmanaged assets cannot be located). Marketers also have wanted to lessen dependencies on outside interactive agencies, prevent the use of unapproved assets, and enhance collaboration both inside and outside the organization.
Operational teams have, at times, needed easier access to asset libraries. Teams in charge of assembling and distributing rich media assets have needed searchable repositories in which appropriate collateral can be easily located. In addition, many organizations that outsource the creation of these assets to interactive and advertising agencies have wanted to be able to give these outside resources access to common repositories rather than rely on FTP or email. Both constituents have, at times, also wanted the advertising agencies, for example, to be included in structured, transparent workflows with members of the operational team. With the explosion in rich media, organizations have needed to manage a larger volume of content assets simultaneously. Increasingly, users have needed to ingest multiple assets at once, often performing format transformation and applying metadata at the same time. Desired efficiencies and capabilities in transforming content assets into different formats and resolutions have also been sought. The ingested content often needs to be formatted for access and display on any device.
IT personnel have wanted to move the assets off shared internal networks and into separate managed repositories. These managers tend to dislike the disorder that comes from storing assets haphazardly on a network shared drives, knowing that they may very well be called upon to help locate those assets later. IT decision-makers have, oftentimes, also wanted to store assets in repositories that facilitate accessing, editing, handling, storing, sharing and auditing, large files in distributed environments. Such IT managers have also increasingly become concerned about securing assets, as well enabling appropriate levels of rights management.
Creative teams typically desire to collaborate with the backdrop of established workflows, thus minimizing disruptions and increasing efficiencies. Individuals who create digital assets have tended to want their established work patterns uninterrupted. Traditionally, they have treated central repositories as locations in which to store finished work, rather than as a system through which they could manage their workflow and foster and facilitate collaboration.
Highly distributed organizations have needed to be able to collaborate on digital assets across geographical boundaries. This need has been a particular challenge with digital assets, as their relatively large size results in slow transfers, for example, across corporate WANs.
At times, digital assets have needed to be distributed in multiple sizes or resolutions. In the past, enterprises have stored assets in multiple formats, complicating update processes and increasing the possibility of asset misuse.
All personnel involved with content have sought ways in which they can interact and collaborate more efficiently. There has be an increased need to transform content production and distribution so that the stakeholders are more enabled, throughout the media production and distribution value chain, to interact and collaborate in ways that result in more dynamic media experiences. With the improvement of operational agility, there could be a breakdown in end-to-end digital workflow barriers between production teams and business units. This breakdown could be facilitated by the sharing of a common technology infrastructure and a single file-based storage system. If designed and built properly, users could instantly access the content that they need, no matter where they are.
Personnel involved with accounting and finance are oftentimes looking for systems and methods that allow them to audit and assess the economic aspects of content. The organizations with which they work could possible drive down expenses and increase profit if and to the extent the content can be evaluated at various points in the content production and distribution lifecycle. The use of virtualized resources through every phase of the media value chain could accomplish these tasks. These capabilities also support the increased monetize of content—with the ability to more efficiently produce and distribute content for any device or platform, and rapidly introduce new services.

The present invention, addressing the foregoing, possesses capabilities spanning asset production through distribution. As such, the invention's elements and steps touch the day-to-day workflows of any number of departments including, for example, creative, IT, marketing, finance, and operations. Although each of these constituencies, and others, have different ‘pain points’ and requirements their considerations can be addressed via use of the present inventive method and system.

### SUMMARY

The present invention comprises a method and system through which various forms of content (for example, individually or collectively, content in the form of audio, video, text, or pictures) may be ingested, managed, converted, repurposed, and delivered to content-accessing users, with access to such content via various devices. In one embodiment of the present invention, the method and system are incorporated in a closed environment, with private access. In another embodiment, the present invention is open to the public, but the controllers of the content may, in their discretion, dictate individual access to content by each content consumer/reviewer that such controllers cause to be authorized. As part of one of the foregoing embodiments or of other embodiments, the present invention may support content lifecycle management, customization, ‘paywall’ monetization, or a combination of the foregoing, with or without other functions/features. The method and system may also include mechanisms and processes for in-depth analysis of content consumption versus behavioral trending through predictive and results based analytics; turnkey or custom solutions for asset publishing and consumption; customer relationship management (CRM); controls for media sharing, workflows and sales functionality; and APIs that facilitate agnostic compatibility with multiple devices and interoperable compatibility with other systems and operations.

In accordance with some of its embodiments, the present invention focuses upon media production capabilities like, for example, broadcast video management, creative tool integration, and watermarking, and in addition has extended our capability to managing assets for delivery to the online channel. It supports image, audio, video, print layout, and presentation content types. Digital assets go beyond just images, as other commonly supported content types include audio, video, CAD drawings, animation such as Flash and Silverlight, and compound documents like PowerPoint presentations. Access to a repository with rich search and metadata support is provided. The present invention also includes a DAM supporting a searchable repository, metadata administration, and tagging functionality.

### BRIEF DESCRIPTION OF THE FIGURES

FIG. 1 is an illustration showing the architecture of an enterprise system for ingesting, managing, converting, repurposing, and delivering content to content-accessing users, in accordance with an embodiment.

FIG. 2 is an illustration showing the architecture of a consumer accessible system for ingesting, managing, converting, repurposing, and delivering content to consumer content-accessing users, in accordance with an embodiment, wherein certain aspects of the enterprise system are not available to the relevant content-empowered users.

It should be noted that references to “an” or “one” or “some” embodiment(s) in this disclosure are not necessarily to the same embodiment, and such references mean at least one.

### DETAILED DESCRIPTION

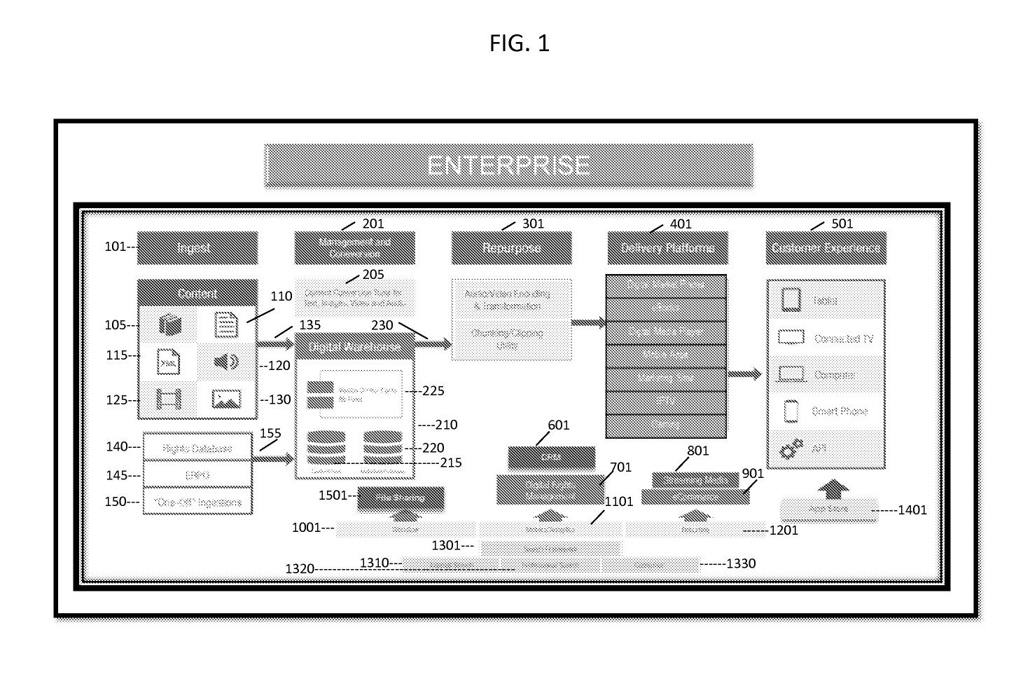

The present invention is illustrated, by way of example and not by way of limitation, in the FIG. 1. As depicted in FIG. 1, the present invention may include the following functions: Ingestion 101, Management and Conversion 201 and Repurpose 301. The foregoing prepare and feed content to Delivery Platforms 401, which facilitates accessible of content-accessing users via Customer Experience 501 devices. It would be apparent to one of ordinary skill in the art that an unlimited number of other types of applications and functions could be used with the foregoing. The embodiment of the present invention shown in FIG. 1 also comprises certain features that facilitate the user's practice of the invention. In particular, FIG. 1 shows the features of Customer Relationship Management—CRM 601, Digital Right Management—DAM 701, Streaming Media 801, eCommerce 901, Workflow 1001, Metric/Analytics 1101, Reporting 1201, Search Framework 1301, App Store 1401, and File Sharing 1501.

### Ingestion 101

In accordance with one embodiment of the present invention, Ingestion 101 is the element and the step of the process through which content-empowered users may ingest any type of content into the storage area used by the particular embodiment. The content may take the form of, for example, Published Works 105, Documents 110, XML 115, Audio 120, Video 125, Still Images 130, or various combinations of the foregoing. To ingest content into the system, the content-empowered user has a multitude of options. Actual ingestion of content is represented in FIG. 1 by Content Transmission 135. For example, the content-empowered user may ingest via ‘drag and drop’ functionality. With this functionality, the content-empowered user can, in essence, drag an icon representing the content element in question from a location in which the icon is displayed on a video screen to a separate location on such screen with a representation of the storage area associated with the present invention. This process may be facilitated, for example, through the use of an Internet-connected personal computer with the content in question (depicted by the icon) in the internal storage of the personal computer or a device connected to it, and a ‘cloud’ storage sever addressable with respect to, and connected via, the Internet with the personal computer. In another embodiment of the present invention, Ingestion 101 may be accomplished through the use of a so-called ‘desktop tool.’ In this version of Ingestion 101, the content-empowered user may use, for example, a computer software application (e.g., a downloaded API) that is stored in the personal computer and supports upload and compression processes. In contrast to the ‘drag and drop’ functionality, the added capability of compression facilitates a faster uploading process. Also, with the ‘desktop tool’ being specifically tailored to the present invention, there can be constant communication, with constant Internet connectivity, between the server and the computer to ensure that the most optimal compress rates are being applied to the content. The ‘desktop tool’ may exist, for example, as a unique software modular enhancement or embedded with other software associated with the present invention. A third option for Ingestion 101 may be a separate application that could provide the desired functionality. For example, the content-accessing user could download a software application that is compatible with one or more devices and/or processes used to upload content. Such devices could be, for example, smart phones, tablets, gaming devices and set top boxes. The application may or may not facilitate compression of the content being uploaded.

Other aspects regarding the ingestion of content may include any one of, multiples of, or a combination of the following:
ingestion of content from any data warehouse, including, but not limited to, Oracle, DB2 (IBM) and SQL (Microsoft)
ingestion and interface with Enterprise Resource Planning/Operations (ERP/O), including, but not limited to, SAP and PeopleSoft
framework supporting ingested content being associated with, for example,
video publishing platforms
monetization systems (e.g., paywall solutions and ad networks)
CRM solutions
content archiving systems (e.g., Media Infinity, Dropbox, Google Drive, Amazon Cloud, and Apple)
DRM platforms (e.g., PlayReady and Fairplay)
CMS (e.g., Joomla and Drupal)

The foregoing aspects are represented, by example, in FIG. 1 by Rights Database 140, ERP/O 145 and “One Off” Ingestions 150.

Ingestion 101 may also support metadata management and tagging of data, such that a content-empowered user has the option to provide metadata, prior to initiating the ingest process. Accordingly, both the content and the associated metadata may be uploaded into the present invention simultaneously. Alternatively, associated metadata may be entered into the present invention prior to or following the ingestion of the related content. Actual ingestion of metadata and other relevant information is represented in FIG. 1 by Data Transmission 155. For metadata integration, the present invention could benefit from the capabilities of options like, for example, Adobe's Extensible Metadata Platform (XMP) (labeling technology), which would enable the content-empowered users to embed data about content, into the file containing the content. With the use of a technology like XMP, desktop applications, mobile applications and the present invention could utilize common methods for capturing, sharing and leveraging valuable metadata—opening the door for more efficient job processing, workflow, and rights management and many more.

In support of managing content, XML files may be used as a set of instructions to change metadata related to content and content transformation and delivery. With XML processing, Arrow compression technology is a preferable option.

All of the foregoing ingestion aspects could support “bulk uploading” of content, allowing the content-empowered user to choose to upload many files at one time.

Importantly, with the use of the present invention, minimal configuration by the content-empowering user is required. This ease of use is due, in part, to the robust APIs that can be managed by and can work in conjunction with the present invention. This ease, flexibility and the automatable nature of the present invention's Ingestion 101 allow for and support ingestion of content from any repository and from any device/systems in ways not previously achievable. All of the options discussed above can be used with the present invention in almost a turnkey manner. In addition, as previously discussed, the present invention is content agnostic with respect to content type. Robust APIs are also available that are readily combinable with the present invention, thus supporting multiple interfaces and integration requirements.

Ingestion 101, as a unique aspect of the present invention, facilities the ability of the present invention to manage all content types in real time at affordable price points (relative to historical pricing for all of the functions of the present invention) in a transaction based approach with multiple compatibilities.

### Management and Conversion 201

As previously indicated, the present invention supports content conversion. Tools 205 facilitate such conversion. The encoding software for video and audio content, for example, may be cloud based. It may also be configured as a SAAS service supporting the transcoding of such content to multiple formats. Such encoding may, for example, support both live and on-demand video. This encoding is helpful in connection with, for example, closed captioning of audiovisual content, converting video to text and subtitling. The present invention will also support e-book conversion by allowing the content-empowered user to upload documents and convert those documents to e-Books. Such eBooks may be, as transcoded, viewable via, for example, e-Book viewers including, without limitation, readers from Apple, Amazon, and Pocketbook. Conversely, the present invention could also be used to convert e-Books to print.

In the embodiment of the invention shown in FIG. 1, content is storable in Digital Warehouse 210. In the configuration shown, Digital Warehouse 210 is a cloud based digital repository. It also has associated with it a digital asset management (DAM) system—DAM 215. DAM 215 supports convenient browsing, intelligent search and secured downloads for all content types. The Digital Warehouse 210 preferably stores the original and converted content files and enables collaboration and sharing of content via secure permissions. The present invention may also store all metadata associated to content (e.g., Metadata Database 220), and information about the rights and business rules (e.g., territory and usage) governing the content (e.g., Rights Database 225). The repository of the present invention also preferably supports, for example,
centralized management and easy organization of files
managed access of content-accessing users to areas or folders for viewing and downloading files
resizing, reformatting and sharing of content using automated tools
approved workflows
reporting and auditing tools for monitoring the usage of files
access/distribution from any device to any device

For instance, the present invention supports functions like, “ordering of content,” where content-empowered users can facilitate online (A) ordering of content by content-accessing users via ecommerce services (such functions may be integrated into the present invention), and/or (B) viewing of content, for example, for a fee via “paywalled” services. The metadata management through, for example, the use of Metadata Database 220, provides a repository for value-added information about elements of content, and is usable, in certain embodiments of the present invention for a variety of purposes including:
cataloging
rights management
licensing
asset ownership
historical information about how an asset was used
rights and permissions

The transcoding services of the present invention, preformed, for example, by Tools 205, allows content-empowered users to have access to unlimited video encoding power, without having, in the present instance, to pay for, manage, and scale expensive hardware and software via a separate means. Digital Warehouse 210 replaces fragmented storage with a single location in which both content-empowered users and content-accessing users can find content files easily via, for example, built in search frameworks. Metadata management allows content-empowered users to:
calculate the return on investment (ROI) of a content asset by viewing its historical usage
determine rights information for a content asset reuse purposes
find out how a content asset was used to evaluate its potential value for a new use
identify licensing parameters to further monetize digital content

The transcoding through the use of, for example, Tools 205, and DAM 215 services of the present invention, in combination, will also support, for example:
management of brand protection and brand consistency across multiple channels. In particular, certain embodiments of the present invention incorporating these services will help increase speed-to-market and prevent duplication and rework (which occurs when previously-created but unmanaged assets cannot be located).
easy access to asset libraries. Teams in charge of assembling and distributing rich media assets need a searchable repository in which appropriate collateral can be easily located. In addition, many organizations that outsource the creation of these assets to interactive and advertising agencies want to be able to give these outside resources access to a common repository rather than rely on FTP or email as well as include them in structured, transparent workflows. These services incorporated into certain embodiments of the present invention satisfy the need for a searchable repository.
the move of the content assets off networks and into a managed repository. IT managers dislike the disorder that comes from storing assets haphazardly on a network shared drive because such IT managers called on to help locate those assets later. IT decision-makers want to store the content assets in a repository that audits the usage of such content and handles the storing and sharing of large files in distributed environments.

The present invention, through DAM 215 and metadata capabilities (through, for example, the use of Metadata Database 220), has the ability to transcode all types of content and prepare them for multiple distribution channels. DAM 215 not only stores and manages the content in single virtual repository but may also have, in certain embodiments of the present invention, a built-in and/or access to a remote eCommerce engine. These features can support ordering of content and the ability to “paywall” all versions of the content. DAM 215 may also support secured file sharing from any device to any device, and allows content-empowered users and content-accessing users to search, tag and access the content. In a preferred embodiment of the present invention, DAM 215 supports transcoding, which allows a single repository to support multiple types of content and transcoded formats. Accordingly, content can be more readily prepared and readied for distribution via multiple channels.

Certain embodiments of the present invention have functionalities that accommodate single storage of content asset and perform format transformations on such asset at the time of distribution. Through the use of cloud technology, the present invention may cache and store frequently used assets on servers closest to the user, and support the replication of assets from a central repository to other system instances.

The content and all of its relevant information, like, for instance, its metadata, may be transmitted together or, as needed, separately, to the next element/step of the present invention through the means represented in FIG. 1 by Processed Transmission 230.

### Repurpose 301

Once the content has been transcoded and is searchable, the repurposing module of the present invention (e.g., Repurpose 301) allows the content-empowered user to “package content” and perform additional editing and collaborative operations, in support preparing the content for delivery channels. Editing capabilities may be integrated into certain embodiments of the present invention via APIs (like, for instance, Editor 305, shown in FIG. 1). The present invention will support the creation and packaging of content in the forms of, for instance, playlists, e-Books and slideshows.

In furtherance of the present invention's editing capabilities performed, for instance, by the element and the step Editor 305 (which are a feature of a preferred embodiment of the present invention), the present invention will analyze content, such as, for example, video files, and displays details information about the codec, bit rate, frame rate, resolutions, etc. The content files may be converted by Encoder 310, which preferably supports multiple formats, such as, for example, 3GP, AMV, ASF, AVI, FLV, MKV, MOV, M4V, MP4, MPEG, MPG, RM, VOB, and WMV.

In one particular embodiment of the present invention, two modes are present. In the simple mode, all the content-empowered user needs to do is select the output format. In then advanced mode, the content-empowered user makes changes to advanced settings such as, for example:
1. Video codec, resolution, bit rate, frame rate.
2. Audio codec, bit rate, sample rate, channels.
3. Additions of text watermarks to, for example, video files.
4. Cutting of, for example, videos at start and end points determined by the content-empowering user.
5. Cropping content with just few clicks
6. Merging multiple files into a single video track.
7. Extracting audio, video or subtitle text from a file—a feature known as demux.
8. Recording, for example, video from a webcam or another movie device.
9. Taking snapshots and creates thumbnails off, for example, video clips.
10. Adding embedded subtitles to, for example, video files.

With respect to the editing of photographs by, for example, Editor 305, a certain embodiment of the present invention will allow content-empowering users to preserves photos quality and sharpness. They can also resize any .jpeg, .png or image file. Further, the present invention supports all popular images formats.

With respect to the creation of playlists generated by, for example, Editor 305, a certain embodiment of the present invention will allow content-empowered users to create playlists from, for instance, their video and/or audio files. Each such user will preferably have a private workspace in which such user can include any playlists such user has created. The content-empowered user will be able to access his or her playlist from anywhere (e.g., home, school, work, and while travelling). Further, videos and/or audios can be flagged/tagged and/or shareable or not within the playlist.

With respect to the creation of eBooks, a certain embodiment of the present invention will convert, through the use of, for example, Encoder 310, many different file types, including, for example, Word®, InDesign®, and PDF via the present invention's DAM 215 services. Further, such embodiments may allow content-empowered users to create various versions of books. In addition, certain embodiments will support, via “fixed layouts”, templates including, without limitation, structures for children's books, cookbooks, and other complicated layouts. Unlike most other eBook publishers, the present invention can accept PDF files.

Supported functionality includes, without limitation:
1. digital magazines that can now be created in HTML5 as well as flash. This functionality enables content-accessing users on iPhones, iPads, Android and other mobile devices to get the very best digital experience, when and where they want to access it, with all the features of the web version.
2. means of reaching audiences on any device. The content-empowered user will be able to convert PDFs into digital editions that can be viewed by content-accessing users on PC, Mac, Netbooks, Tablets, iPads, iPhones, Kindles and other e-readers.
3. embedding and viewing magazines from, for example, business fan pages, meaning readers have more reason to follow content-empowered users on, for example, Facebook.
4. reader output options that allows content-empowered users to create ‘eBooks’ for the growing eReader market that include, for example, Kindle, Nook and iBooks.
5. auto detection of links from original PDF(s) of content (whether these are embedded links or simply typed links). Along with the foregoing is the ability, after detection, to then place the live links in digital packages—saving valuable time.
6. capability for readers to have a unique reading experience, flipping through the pages like a real book, watching embedded videos and flash, listening to related audio clips and having the ability to click through to further information on the internet.
7. ability to store all versions of the “packaged content” a DAM 215 server, thereby enabling content-accessing users to browse through a graphical library of previous or related digital editions, so archived versions or back issues can always be accessed by the audience instead of being lost never to be viewed again.
8. fully customizable output, whereby the look and feel of both the skin and interactive features may be customized by choosing from preferred colors, background, sounds, visual page transitions and button controls. The digital publications can therein match the desired brand so it really looks the part.
9. ability to embed photo galleries and slideshows with the use of an a image gallery tool within digital publications. The present invention in certain embodiments will expose content-accessing users to content that is shareable with other platform users and available for purchase.
10. friendly SEO abilities, wherein software can be created with multiple SEO profiles. Content-empowering user can customize the page title, description and keywords and then can add the html pages to the applicable sitemap to ensure search engine visibility.
11. offline, DVD, CD and USB versioning. Whether the content-accessing users are online at work or on their journey home from work on the train; publications can be viewed at anytime, information provided as to when and how they want to consume it. Certain embodiments of the present invention enable the creation of DVDs or USBs with digital editions to distribute, for example, at trade shows or hand to customers.

Ad Insertion is a separate function through which, via the present invention's DAM 215 and Metadata Database 220, ads may be inserted throughout the various types of content. Such insertion may be supported via APIs from major ad networks, such as, for example, Google, Spot Exchange, Tremor Media, YuMe and many more.

The repurposing and packaging as enabled by the present invention help to transform content production and distribution by enabling users throughout the media production and distribution value chain to interact and collaborate in new ways, and create more dynamic media experiences and product. They also assist in the monetizing of content more effectively, with the ability to produce, repurpose, package, and distribute content for any device or platform, and rapidly introduce new services. Different production teams can work on content at the same time, and collaborate with users across the media value chain.

Accordingly, content-empowered users have the ability, potentially in one single embodiment of the present invention, (A) to quickly edit, for example, video and audio and generate playlists and “customized” packages; (B) to package content all types in one place to create new product instantaneously; and (C) to decide on ad insertion where and whenever during the process of “packaging”.

### Delivery Platforms 401

Certain embodiments of the present invention will support, for example, the delivery of content to many and various “channels.” For instance, the Internet connectivity provides an opportunity to link content players in a particular market, reducing friction in both the buying and selling experience. The present invention will allow both the enterprise users and the consumer users to create market places and participate in marketplaces. As indicated above, the transformation services (e.g. as performed in Repurpose 301) support a singular repository for all types of content and the paywalls to support marketplace activities. Enterprises operations can invite content owners, partners, vendors to participate in a marketplace supporting marketing and yield services. Enterprises can offer a single, one-stop-shop for any purchases of content in virtually any format. The market place, because it will be used by both the enterprise and consumer users can become a marketplace that naturally pulls on both the consumer and supplier side of the market. The present invention's DAM 215 services will support natural aggregation of suppliers, and will support an organic aggregation demand, with each step, it should get easier to acquire the incremental consumer as well as the incremental supplier.

Delivery Platforms 401 represent, and in FIG. 1 include examples of, formats and channels for distribution. The list of examples—digital market places, eBooks, digital media players, mobile apps, marketing sites, IPTV, and gaming, none of the foregoing of which is in and of itself an essential element/step of the present invention—is not exhaustive. By way of example, the present invention's eBook services will support the transformation of eBooks and will be viewed through computers, Smartphones, and eBook readers. The eBooks may have a built in paywalls such that a content-empowered user can instantaneously create, store, share and sell his or her eBooks. The present invention's transcoding services will support all types of contents and support for multiple media players. It will transcode, for example, video and audio files for playback in any format. A built-in reliable IP-based digital media player, when incorporated, will handle, for example, display and playback of compelling interactive multimedia-including high-definition live broadcasts or on-demand video, Flash animations, HTML5 content, and artwork.

With respect to mobile applications, for example, certain embodiments of the present invention have such mobile application component for users (enterprise and/or consumers) to access, share and sell their content. Such embodiments may also support delivery of content via APIs and RSS feeds to mobile applications or mobile apps are applications developed for small handheld devices, such as, for example, mobile phones, Smartphones, PDAs and so on.

Content can also be delivered to IPTV partners including, for example, Roku and Apple TV, or via gaming platforms, including, without limitation, Xbox, Nintendo, and Sony consoles.

Accordingly, the present invention provides for the preparation and delivery of various content types to multiple delivery platforms.

### Customer Experience 501

Certain embodiments of the present invention support access from any device to the “digital habitat” (a place where all content lives) to any device. As shown in FIG. 1, such device may include, for example, tablets, connected televisions, computers, Smartphones, and APIs. Such embodiments support access from, for example, tablets, Smartphones, computer, smart TVs and any other device that is Internet connected and has browser capability. The invention's APIs may include, for example, support for Built in Integration with
video publishing platforms
monetization (e.g., paywall solutions and ad networks)
CRM solutions
ERP solutions
content archiving systems
transcoding solutions
CDN agnostic
content management systems
ad networks

The suite of APIs and tools allow content-empowered users to control and manage their content and the players for their content, while also allowing for the creation of unique viewing experiences.

From a single embodiment of the present invention, a content-empowered user can instantaneously deliver to multiple channel opportunities. The invention will allow such enterprise and consumers users to fully monetize content on all available channels.

The Web APIs, or “Application Program Interface”, of certain embodiments of the present invention are a set of routines and protocols that provide building blocks for computer programmers and web developers to build software applications based on our platform. For example, imagine a developer looking for all video content with the tag “waterfalls.” Web APIs allow developers to build web pages and web based applications (known as “mashups”) using data from multiple online sources. The present invention will support all current data formats such as XML, and JSON.

Although the target audience for a Web API is usually the web development community, they can also be beneficial to content-accessing users as well as the API providers themselves.
1. Web Developers: Web APIs allow advanced functionality and features to be integrated into the websites that they create. There is also greater customization and flexibility with Web APIs than standard “copy and paste” widgets.
2. Content-accessing users: A good Web API can help increase the usefulness of a website and make the site interactive and more enjoyable.
3. API Providers: A well built API that is widely used by the web development community can be a powerful marketing tool because it can:
Help build brand loyalty
Increase interest in the company's products and services
Increase website traffic
Provide useful tools to consumers
Convey company messaging.

### Overarching Components

CRM 601. In certain embodiments of the present invention, users may register and track their behaviors for viewing, selling, sharing and collaborative activities. CRM 601 capabilities will allow enterprise and consumers users to
1. Find, attract, new content-accessing users for their content, and nurture and retain those they already have.
2. Entice former content-accessing users back into their content.
3. Effectively manage the costs of marketing and client service.
4. Support all activities related to consumer engagement, sales and all other content-accessing users based activities.

The present invention, in certain embodiments, will use a combination of CRM and social metrics to build cross—engagement reports for example number of people who viewed, for example, a particular video and shared it on, for instance, Facebook.

Digital Rights Management 701—The function, which is discussed in more detail above, can also be used across various elements/steps of the present invention.

File Sharing 1501—Certain embodiments of the present invention preferably have DRM built into file sharing, building security and usability into the files themselves. In such cases, the content may be secured no matter how enterprise files are sent, synched or shared.

Video and Audio—Unauthorized use of, for example, clips or episodes on the Web is a problem for those who own the rights to video content. This user-generated content (UGC) undercuts video originators' investment in their property—their video content. Certain embodiments of the present invention will assist content-empowered users in getting the broadest audience for their digital content while reclaiming the value of UGC that is all over the Internet and out of their control. The proprietary digital content identification software of the present invention helps teams locate, protect and most importantly monetize online video content for brands and celebrities. The video identification and monetization technology helps video creators and those who own rights to video content keep control of their content. When, for example, videos, audio and publishing content, are hosted on applicable networks, the present invention will ‘crawl’ the web to detect unauthorized uses (clips, full episodes, edited versions) of the content-empowering user's content. When the present invention finds it, arrangements can be made to redirect the ad revenue, or to block the content from appearing at all. Certain embodiments of the present invention use two pathways to ‘crawl’ the Web and find original video content. The tool locates keywords in meta-data (text form) and also matches video “identifiers.” Such embodiments can detect unique attributes such as, for example, “a celebrity face—Shaquille O'Neal's face and find his branded content.” When certain embodiments of the present invention detect unauthorized uses of branded content, the embodiment can claim the content for the applicable owner. Whenever, for example, new pirated clips or episodes are added to the Web, certain embodiments of the present invention can continue to identify and claim them for their owners.

Book/Magazine/Photos—_The present invention will support, for example, Adobe Content Server 4, the leading open, cross-platform protection solution in the industry with more than 150 publishers and content aggregators using Adobe's technology today. It also treats the copy/paste and printing setting as disabled for all print content. The user will have the opportunity to manage these settings.

Streaming Media 801—Certain embodiments of the present invention support streaming media, both live and on demand for video and audio. Such embodiments may be integrated with several CDNs (content delivery networks) for optimal user experience.

ECommerce 901—Certain embodiments of the present invention support content ordering/sales for both enterprise and the consumer user. Content can be associated with specific paywalls for easy user engagement and workflow.

Search Framework 1301—The search framework aims to provide a unified framework for content indexing, sharing, search and retrieval. The present invention crosses the entire “ecosystem” and all types of content (video, audio, print). This means that its search is across all applicable repositories, fileshares, desktops and smart devices. Search supports the content being “ingested” one and leveraged across the entire ecosystem—to extract business value and protect from information risk. Search will support queries that will retrieve any available relevant content. Our solution is best for “big data search” by integrating search engines that support:
Search all data for more value. Bring all relevant content back to users—unstructured and structured, internal and public.
Real-time updates. Real-time results. When documents are updated or inserted, they are available for search immediately.
Able to query all types of data. Structured, semi-structured, and unstructured content are all supported within the same queries.

Comprehensive full-text query provides search and retrieval of documents or parts of documents with enterprise-class, full-text query. The capabilities include word and phrase, stemming, Boolean, wildcards, case sensitivity, punctuation sensitivity, diacritic sensitivity, and weighting. Document-level relevance boosting to support “page ranking” ensures the most relevant results. Options for relevance algorithms include term frequency/inverse document frequency, term frequency only, and simple term match. Results can be ordered by relevance or content metadata (in string, numerical, or date/time formats). Proximity boosting ensures that terms found close to each other are scored higher than terms found farther apart. Scanning for search terms in document results is no longer necessary because text snippets that match the query are highlighted for ease of discovery. This is typically used for results lists, but also can be used as a search and replace function. Basic language support for more than 200 languages. Advanced language support includes stemming, tokenization, and collation rules for 14 languages to enable more precise, language-specific search. Developers can take advantage of the search APIs that support popular functionality such as automatic query text parsing, constrained, faceted navigation, snippeting, and search term completion. User can easily build lexicons for all words in the database, support custom dictionaries that affect stemming behavior, customize a thesaurus to suggest synonyms by user or user group, and search on distinctive terms to ensure you get the best results. They can also ensure high-speed lookups of values in elements using range indexes. This enables fast range querying and popular search functionality such as faceted navigation and term auto-suggestion. Search results will return only the records that content-accessing users are authorized to see. If permissions are updated on documents, those updates are reflected automatically and immediately in the indexes and in subsequent searches. In many industries, location data is an important aspect of information search. By combining geographic data and content such as text, imagery, and video, users can more easily analyze, exploit or assimilate information. By narrowing the scope, this combined analysis leads to greater accuracy, new knowledge, and better decisions. Users may need to know which regions are completely within the boundaries of a specified containment region. Polygon intersection and region intersection filters let users identify which geographic areas touch, or intersect another specified area. The containment region is often a polygon specified by a series of vertices, but also can be a circle or a box.

In the embodiment of the present invention shown in FIG. 1, Search Framework 1301 may itself consist of specific operations or functionalities, such as, for example, Internal Search 1310, Professional Search 1320, Consumer 1330, combinations of the foregoing, and/or additional elements.

Workflow 1001—Certain embodiments of the present invention allow for automation of business process, whereby work to be shared efficiently between workers. Being able to capture, manage and locate unstructured content is essential for moving an organization forward. But intelligently incorporating such information into the flow of business is also required to truly transform processes—making them more automated, accurate and agile. The present invention will support and unlock the full potential of distributing information anywhere it is needed across an organization.

Metric/Analytics 1101 and Reporting 1201—The present invention, in desirable embodiments, captures all registration data, trends and behaviors, and usage including what content is being shared and by whom and social engagement. Such embodiments will report on the aforementioned and empower the user to fully manage “Big Data”, and create KPIs for advertising, product development and content creation.

App Store 1401—With accessible via Smartphones, tablets, smart TVs and other smart devices, the present invention will support downloadable APPS that can be customized for, for instance, user engagement and content monetization.

The enterprise version of the present invention allows enterprises to share content via B2B and B2C models with full control as to where, when and to what device the content is viewable on. The content can be immediately withdrawn from the person who has access to that content no matter the device they accessed it from.

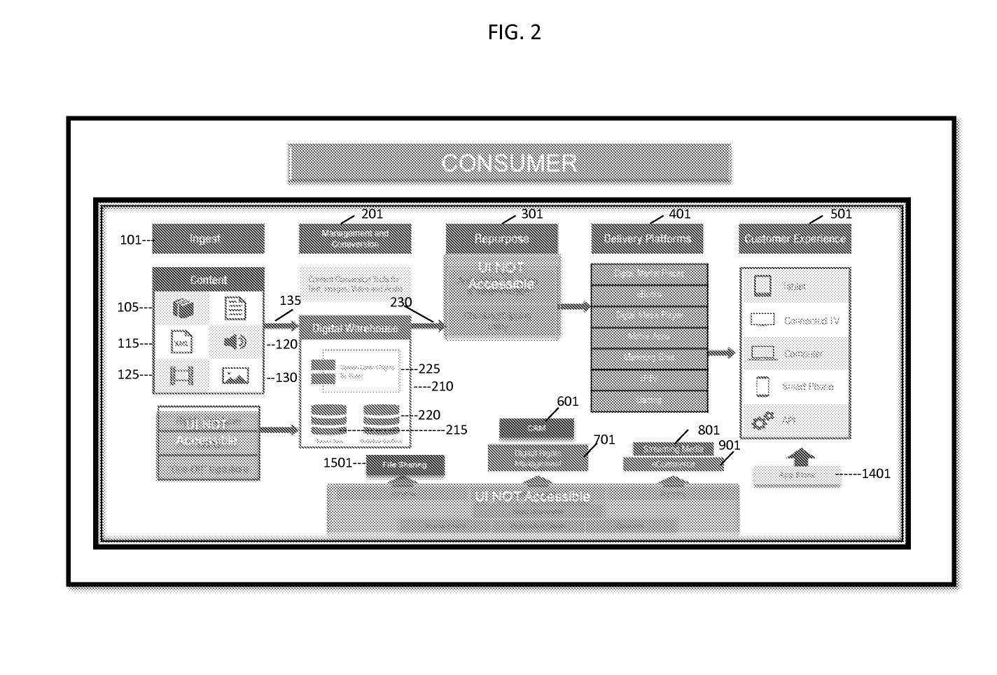

As depicted in FIG. 2, the present invention may include, similar to the version of the present invention shown in FIG. 1, the use of functions, such as, for example aspects of Ingestion 101 and Management and Conversion 201. In this embodiment, users do not have access to the equivalent of Rights Database 140, ERP/O 145 and “One Off” Ingestions 150 shown in FIG. 1. Such users also do not have access to the equivalent of FIG. 1′s Repurpose 301. Also, the equivalents of Workflow 1011, Metric/Analytics 1021, Reporting 1031, are unavailable. It is believed that the individual content-empowered user will benefit most from the Ingestion 101 and Management Conversion 201. Accordingly, such users would not have access to and thus would not have, as part of their billing, the other elements/steps of the present invention. Notwithstanding the foregoing, it would be apparent to one of ordinary skill in the art that an unlimited number of other types of applications and functions could be used with this version of the present invention. The embodiment of the present invention shown in FIG. 2 also comprises certain features that facilitate the user's practice of the invention.

The consumer version of the present invention, as shown in FIG. 2, serves as an alternative to the historically reality of consumers storing content on their PCs, and, as they enter the post-PC era, using multiple connected devices, to include smart phones, smart cameras, tablets, set top boxes etc. The increased use of these non-PC devices has led to a massive increase in new user-generated content that requires storage and immediate interaction with content from anywhere to anywhere.

The present invention may, in certain embodiments, use cloud online storage and sync services to support the use of the personal cloud, simplify the direct-to-cloud model, allowing users to directly store user-generated and other content in the cloud. This sharing approach is a secured and managed by the consumer.

### Additional Thoughts

The foregoing descriptions of the present invention have been provided for the purposes of illustration and description. It is not intended to be exhaustive or to limit the invention to the precise forms disclosed. Many modifications and variations will be apparent to the practitioner of ordinary skilled in the art. Particularly, it would be evident that while the examples described herein illustrate how the content lifecycle may look—end-to-end, certain elements/step are essential to the present invention while others are supplemental. Further, other elements/steps may be used for and provide benefits to the present invention. The description of an embodiment of the present invention as shown in Exhibit A is provided for purposes of illustration. It will be evident that the techniques described herein may be applied using other means.

The embodiments were chosen and described in order to best explain the principles of the invention and its practical application, thereby enabling others of ordinary skill in the art to understand the invention for various embodiments and with various modifications that are suited to the particular use contemplated.

1. A method of managing and delivering digitized content of various forms and formats comprising the steps of:
ingesting such content;
converting such content if and as desired by a user of such method;
repurposing such content if and as desired by a user of such method; and
delivering such content for access via devices of at least one content-accessing user of the method as designated by a user of such method.

2. The method of claim 1 wherein the content is audiovisual.

3. The method of claim 1 performed within a software-based platform.

4. The method of claim 1 wherein the steps of ingesting, converting, repurposing, and delivery are managed by the same user.

5. The method of claim 1 wherein the steps facilitate the interoperability of a turnkey embodiment of the method, thus increasing efficiencies.

6. The method of claim 3 performed within a cloud-based ecosystem configuration.

7. The method of claim 1 performed via centralized governance, whereby a user controls an enterprise application solution.

8. The method of claim 4 wherein the content ingesting user and the content-accessing user are the same.

9. The method of claim 3 wherein the user managing at least the delivery step dictates at least one user that will have access to such content via the delivery step.

10. The method of claim 9 wherein the user managing at least the delivery step dictates the device through which such content is accessible.

11. The method of claim 1 wherein the ingest step is accomplished via use of a device selected by the ingesting user.

12. The method of claim 1 further comprising the steps of
analyzing data associated with such content,
collecting and managing information associated with at least one user, and
enabling the secured sharing of such content, such data, and such information as desired by at least one user.

13. The method of claim 1 wherein the steps are customizable as desired by a user for the user's purposes.

14. The method of claim 1 wherein the steps support automated workflow of business processes through shared user efficiencies.

15. A comprehensive e-commerce-supported method of managing and delivering digitized content of various forms and formats comprising the steps of:
ingesting such content;
converting such content if and as desired by a user of such method;
repurposing such content if and as desired by a user of such method; and
delivering such content for access via devices of at least one content-accessing user of the method as designated by at least one user of such method, wherein such delivery step includes a paywall functionality controlled by at least one user.

16. A turnkey system for managing and delivering digitized content of various forms and formats comprising:
means of ingesting such content;
means of converting such content electronically connected to such ingesting means, whereby at least one user, as desired, may convert such content;
means of repurposing such content, whereby at least one user, as desired, may repurpose such content, with such repurposing means electronically connected to such ingestion means; and
means of delivering such content, whereby at least one user, as desired, may deliver such content, with such delivery means electronically connected to such ingestion means.

17. The system of claim 16 wherein the repurposing means is electronically connected to the converting means, which in turn is electronically connected to the ingestion means.

18. The system of claim 16 wherein the delivery means is electronically connected to the repurposing means, which in turn is electronically connected to the ingestion means.

19. The system of claim 17 wherein the delivery means is electronically connected to the repurposing means.

20. The system of claim 16 further comprising means for centralized governance of such system as a enterprise application solution.
